(19) United States
(12) Patent Application Publication
(10) Pub. No.: US 2015/0155115 A1
(43) Pub. Date: Jun. 4, 2015

(54) Method And Device For Switching A Contactor

(71) Applicants: Gunnar Johansson, Vasteras (SE); Mats Johansson, Vasteras (SE); Erik Johansson, Vasteras (SE)

(72) Inventors: Gunnar Johansson, Vasteras (SE); Mats Johansson, Vasteras (SE); Erik Johansson, Vasteras (SE)

(21) Appl. No.: 14/402,388

(22) PCT Filed: May 30, 2012
(86) PCT No.: PCT/EP2012/060123

§ 371 Date: Nov. 20, 2014

(51) Int. Cl. H01H 9/56

(52) U.S. Cl. CPC H01H 9/563

(57) ABSTRACT

A low voltage contactor for connecting and disconnecting a three-phase load to an electric power including a coil, main contacts operated by the coil and an electronic control circuit for controlling voltage supplied to the coil. The electronic control circuit includes a pre-arranged time point selection scheme and is further adapted to select a time point from the pre-arranged time point selection scheme as a time delay, and initiate an instant opening command based on the selected time point.

### FIELD OF THE INVENTION

The present invention relates to a method and a device for switching a low-voltage contactor for operating a three-phase load, wherein the contactor includes an actuating unit having a coil, main contacts operated by the coil and an electronic circuit for controlling voltage supplied to the coil. In particular, the invention relates to initiating switching commands when controlling the coil. Low voltage is commonly defined in a range of up to 1000V AC.

### PRIOR ART

A contactor is an electrically controlled switch device used for switching an electric power or control circuit of an electrical load connected to an electric circuit. The electrical load may be a three-phase load. To connect such an electrical load, the contactor comprises a contacting unit including three main contacts configured to connect or disconnect the load to a main electric network and an actuating unit including a coil for actuating the main contacts. For controlling voltage supplied to the coil, the contactor further includes an electronic control circuit. Typically, control voltage of the electronic control circuit is supplied by an electric circuit drawn from, for example, one or two of the three phases.

Due to synchronization effect between the main electric network and the control voltage, each of the main contacts connected to one of the three phases may switch (open or close) at almost the same phase angle in all switching operations. The electrical load or burden on each of the contacts will therefore differ substantially, which results in substantially different arc energies. Consequently, the most electrically affected is subject to higher erosion than the others. Therefore, the thickness of the contact material of the affected contacts may decrease faster. This leads to different/uneven erosion levels of different contacts. This means that the service time of the contactor is limited by the contact that fails first.

A patent U.S. Pat. No. 6,671,157 B1 discloses a method for controlling a drive coil of a contactor having contacts for a load current. The method includes providing an electronic drive control apparatus including a microcontroller. A randomly selected constantly varying time delay is applied in the microcontroller after a time at which a supply voltage has built up at the electronic drive control apparatus and before the a time at which the supply voltage is measured.

Another patent U.S. Pat. No. 6,927,959 B2 discloses a method for switching contacts of a switch device for ensuing optimum service life, wherein an optimum switching point, in terms of the load of one of the switching contacts, is determined depending on a current path that is measured during the switching process and the switching point is shifted by a delay time from switching operation to switching operation. The optimal switching point is preferably determined by self-calibration of the switching device. To be able to determine the optimized switching time, the current in at least one of the three phases is measured,

### OBJECTS AND SUMMARY OF THE INVENTION

The object of the present invention is to provide an improved method of switching contacts of a contactor to ensure uniform wear of different contacts and therefore to enable a contactor carried the method thereby have a longer service time.

This object is achieved by the method as defined claim 1. The method comprises steps of
providing an electronic control circuit for controlling voltages supplied to the coil,
constructing a pre-arranged time point selection scheme including a plurality of time points distributed in a period of the control voltage of the electronic control circuit,
selecting a time point from the pre-arranged time point selection scheme,
supplying the selected time point as a time delay,
initiating an instant opening command based on the selected time point.

Due to the fact that the invention initiates instant opening commands based on a pre-arranged time point selection scheme that includes a plurality of time points distributed in a period of the control voltage of the electronic control circuit, the invention is able to distribute instant opening commands to each of the main contacts. Consequently, erosions and heats generated by arcs are distributed evenly on each of the contacts in a determined way, which increases the service life of the contactor.

According to one embodiment of the invention, the method further comprises steps of dividing the time points in the pre-arranged time point selection scheme into a plurality of groups. Each of the groups includes at least three time points with a pre-defined interval so that the corresponding opening commands are distributed on each of the three phases. One advantage is that with the pre-arranged scheme, burdens on the contacts are shifted from one phase to the other and eventually distributed the burdens on each of the contacts, which even facilities the rated making, breaking capacity tests and operational performance tests. This is because that typically such tests result in the extensive heat dissipation at the main contacts. By distributing the opening commands on each of the main contacts, the thermal burden is distributed on each of main contacts. Thus, the risk of overheating a single main contact is significantly decreased.

Preferably, the pre-defined interval is calculated based on a phase angle of either 60° in a half period or 120° in one period of the control voltage. In a three-phase electrical system the phases have an offset of 120° between each other, by shifting the interval 60° in a half period or 120° in one period of the control voltage, the time points of the time point selection scheme are ensured to be distributed in the period of the control voltage, which consequently ensures that instant opening commands will be evenly distributed on each of the contacts.

According to another embodiment of the invention, the method further comprises steps of selecting a time point from a group sequentially, selecting a time point from the successive group in the case that all of the time points from the preceding group have been selected, and performing repeatedly the above two steps. By providing a time point selection scheme, the invention makes it possible to systematically select time points and based thereon instant opening commands are initiated to be well distributed on each of the main contacts. Therefore, it prevents that a sequence of opening operations are initiated on the same main contact and ensures distributed erosions on each of the main contacts.

According to yet another embodiment of the invention, the method further comprises a step of shifting time points in a preceding group with a pre-defined offset to construct time points in a successive group so that each of the main contacts is open at different phase angles. Preferably, the pre-defined offset is calculated based on a phase angle in a range of 5°-15°.

The present method will be carried out by a low-voltage contactor as defined in claim 7. The low voltage contactor is used for connecting and disconnecting a three-phase load to an electric main network. The contactor includes a coil, main contacts operated by the coil and an electronic control circuit for controlling a voltage supplied to the coil, characterized in that the electronic circuit include a pre-arranged time point selection scheme and is further adapted to select a time point from the pre-arranged time point selection scheme as a time and initiate an instant opening command based on the selected time point.

It is advantageous to initiate an instant opening command based a pro-arranged scheme, which does not need measurement values compared with the prior arts. Therefore, an inexpensive contactor can be achieved.

According to one embodiment of the invention, the time point selection scheme has a plurality of time points distributed in a period of the control voltage of the electronic control circuit. Furthermore, the time points in the pre-arranged scheme are divided into groups, each of the groups including at least three time points distributed in the period with a pre-defined interval and time points in a successive group constructed by shifting time points in a preceding group with a pre-defined offset.

Preferably, the time point selection scheme is stored in memory storage in any form of non-volatile memory, such as ROM, EPROM and EEPROM etc. Therefore, the scheme is kept alive even when the electronic circuit is switched off.

### BRIEF DESCRIPTION OF THE DRAWINGS

The invention will now be explained more closely by the description of different embodiments of the invention and with reference to the appended figures.

FIG. 1 is a flow chart of invented method for switching a contactor, according to one embodiment of the invention.

FIG. 2 is a flow chart of a time point selection scheme based thereon an instant opening command is initiated, according to another embodiment of the invention.

FIG. 3 is a three-phase diagram of illustrating an offset of 120° between the three phases.

FIG. 4a shows a schematic diagram of a low-voltage contactor, according to one embodiment of the invention, wherein the control voltage of the contactor is drawn from one of the three phases.

FIG. 4b shows a schematic diagram of a low-voltage contactor, according to another embodiment of the invention, wherein the control voltage of the contactor is drawn from two of the three phases via a transformer.

### DETAILED DESCRIPTION OF PREFERRED EMBODIMENTS OF THE INVENTION

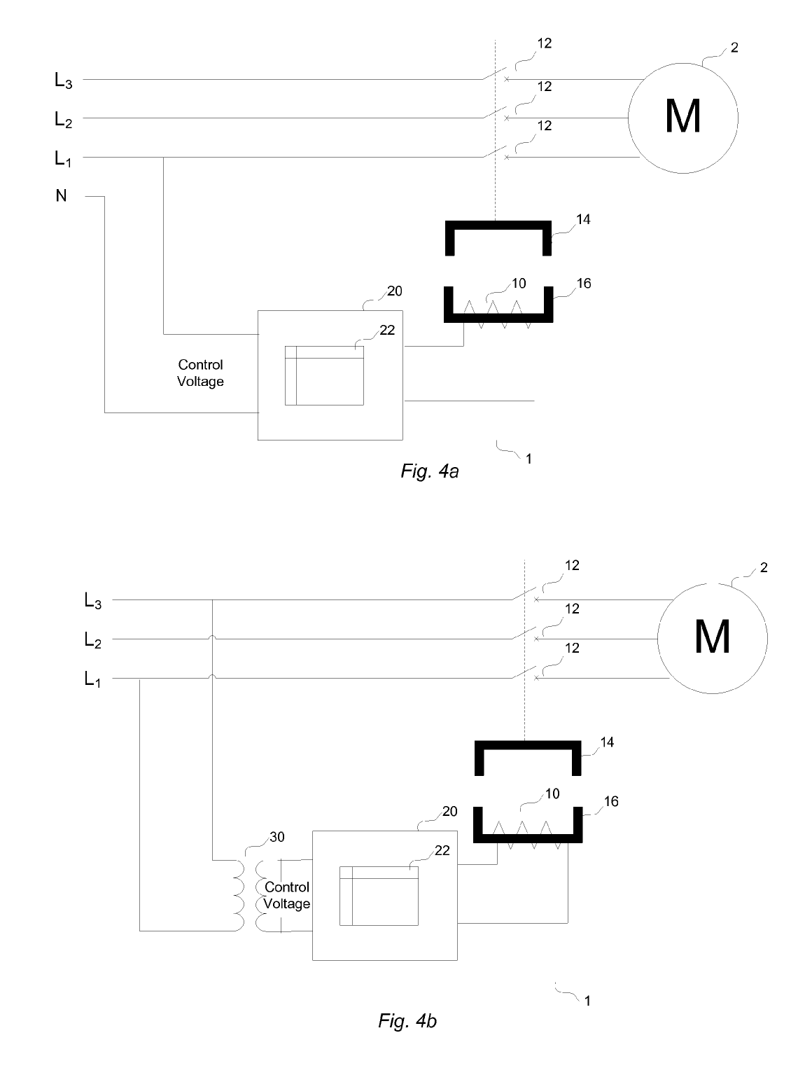

FIG. 4a shows a low-voltage contactor 1, according to one embodiment of the invention. The low-voltage contactor 1 is used for connecting or disconnecting an electric load 2, in this example, a motor, to a main electric network having three phases L₁, L₂, L₃.

The contactor 1 includes three main contacts 12 connected to each of the three phases L₁, L₂, L₃ of the main electric network, an actuating unit including a coil 10 and a fixed magnet core 16 and a movable core 14, an electronic control circuit 20 for controlling voltage/power supplied to the coil 10. Each of the main contacts comprises a fixed contact and a movable contact connected to the movable core 14. The coil 10, the fixed magnet core 16 and the movable core 14 are arranged for actuating the main contacts 12 and therefore make connection and disconnection operations.

In this example, the control voltage of the electronic control circuit is supplied by an electric circuit including connections to the neutral and the phase L₁. However, it should be understood that control voltage of the electronic control circuit can be provided differently, for example from two of the three phases or from a transformer 30 that is connected in the main network as shown in FIG. 4b.

The electronic control circuit 20 further comprises a pre-defined time point selection scheme 22. The electronic control circuit 20 is, among other tasks, further adapted to initiate an instant opening command based on the pre-defined time point selection scheme 22.

The time point selection scheme 22 may be kept in a memory-storage in any form of non-volatile memory, for example, ROM, EPROM and, EEPROM etc. Therefore, the scheme will be kept alive even when the electronic circuit is switched off.

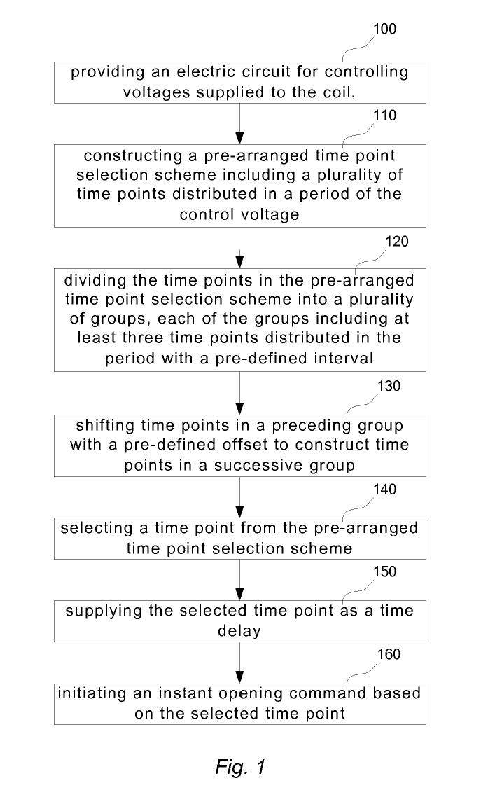

With reference to FIG. 1, the electronic control circuit 20 is provided for controlling voltages supplied to the coil, step 100. The pre-arranged time point selection scheme 22 is constructed and includes a plurality of time points distributed in a period of the control voltage, step 110.

The time points are further divided into a plurality groups. Each of the groups contains at least three time points that are distributed in the period with a pre-determined interval calculated based on a phase angle, step 120. Furthermore, the time points in a successive group may be optionally constructed by shifting corresponding time points in the preceding group with a pre-defined offset calculated based on a phase angle, step 130.

For example, after steps 120 and 130, a time point selection scheme for a half of control voltage may include following time points corresponding to the following sequence {(0°, 60°, 120°), (10°, 70°, 130°), (20°, 80°, 140°), (30°, 90°, 150°), (40°, 100°, 160°), (50°, 110°, 170°)}. Thus, the scheme includes six groups. The pre-determined interval in this sequence in each group is 60°, while the pre-defined offset for the corresponding time points of two successive groups is 10°. Preferably, the pre-defined offset is calculated based on a phase angle in a range of 5° -15° in order to have a complete coverage of the main contacts so that opening commands are initiated and distributed on each of the main contacts. For example, an offset calculated based on a phase angle 30° will result in only two different groups, which does not enable well-distributed opening commands on each of the contacts.

Therefore, each of the groups includes time points such that the corresponding opening commands are distributed on each of the three phases, which results in an evenly distributed burden on each of the contacts. Furthermore, the offsets between the corresponding time points of the groups ensures that contacts connected to a phase will not be always open at the same phase angle. By providing time points at different phase angles, it ensures that none of the main contacts will have most of the burden the whole time; otherwise, one or two of the contacts will be most burdened. Consequently, even burden of the contacts is enabled. This means that the erosion on the mostly burdened contact is decreased while the erosion on the less burdened contacts may be increased. However, overall it is advantageous because it is the most eroded contact that limits the service time of a contactor.

In a similar way, a time point selection scheme may also be constructed for a complete period of control voltage by having an interval 120°, for example.

As shown in FIG. 3, the phases of a three-phase electrical system have an offset of 120° between. When the contactor 1 is open at point a, the voltage over phase L₁ will be higher than phases L₂ and L₃, which results in higher erosion and heat on the contacts connected to L₁. By introducing an interval of 120° in a complete period, the next opening command will be initiated at point b where the voltage over the phase L₂ will be higher than the other two phases. A further interval of 120° results that the next opening command will be initiated at point c where the voltage over phase L₃ is higher. Therefore, the burden on the contacts is shifted from one phase to another. Consequently, erosions and heats generated by arcs are evenly distributed to each of the contacts. It should be understood that point c and d are equivalent in absolute values of the voltage, which means that the opening commands at point c and d have an equivalent effect.

Analogously, an interval of 60° will provide an equivalent effect in a half period. Although, it may be preferably to choose 60° and 120° for a half period or an complete period, it should be understood that the principle of distributing time points over a period may be applied by selecting another interval. This principle may be even applied when selecting an offset for shifting time points in the groups. For example, an offset of 10° may result in the same effect as offset 190° for a complete period. Therefore, either of them may be selected to be an offset. Furthermore, groups may be ordered differently. For example, the following sequence is also applicable {(0°, 60°, 120°), (30°, 90°, 150°), (10°, 70°, 130°), (40°, 100°, 160°), (20°, 80°, 140°), (50°, 110°, 170°)} to construct time points in a time point selection scheme, although, comparing to the previous one, the groups are in a different order.

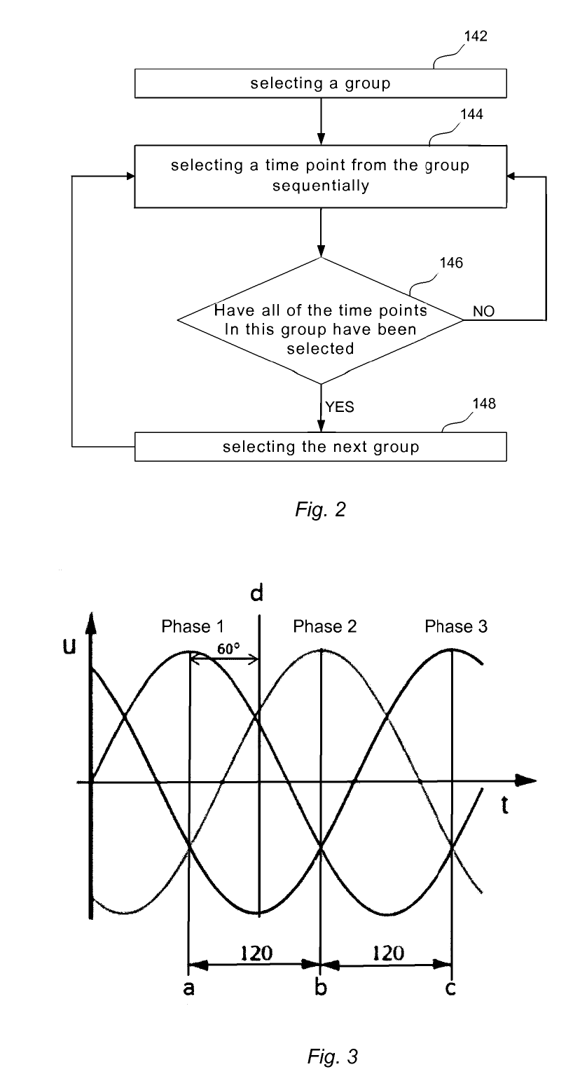

With reference to FIG. 2, the electronic circuit may further be adapted to select a time point from the pre-arranged time point selection scheme, step 140. With reference to FIG. 2, a selection may start by selecting a group in the scheme and selecting time points sequentially, or one by one from this group, steps 142 and 144. Once all the time points have been selected, step 146, the selection moves to the next group 148. When the time points in all of the groups have been selected, the selection will start over again. However, it should be understood that FIG. 2 is only one of many possible examples of selecting a time point from the pre-arranged time selection scheme. A different selecting sequence may be also applicable as long as each of the time points in the pre-arranged time selection scheme is selected once before the selection of the time points starts again.

The selected time point is further applied as a time delay to initiate an instant opening command, steps 150 and 160. In this way, opening commands are initiated evenly to each of the contacts and each of the contacts is open in different phase angle in a period of control voltage. Thus, the consequence of the unwanted synchronization effect is prevented.

1. A method for switching a low voltage contactor connecting a three-phase load and including a coil and three contacts operated by the coil, wherein each of contacts is connected to each of the phases, the method comprising,
providing an electronic control circuit for controlling voltages supplied to the coil,
characterized in that the method further comprises steps of
constructing a pre-arranged time point selection scheme including a plurality of time points distributed in a period of the control voltage of the electronic control circuit,
selecting a time point from the pre-arranged time point selection scheme,
supplying the selected time point as a time delay, and
initiating an instant opening command based on the selected time point,
wherein the time points are constructed in the pre-arranged time point selection scheme in a way such that the initiated opening commands based thereon are evenly distributed on each of the contacts.

2. The method according to claim 1 further comprises dividing the time points in the pre-arranged time point selection scheme into a plurality of groups, each of the groups including at least three time points distributed in the period with a pre-defined interval.

3. The method according to claim 2 further comprises
selecting a time point from a group sequentially, or
selecting a time point from a different group upon all of the time points from the preceding group have been selected, and
performing repeatedly the above two steps.

4. The method according to claim 2, wherein the pre-defined interval is calculated based on a phase angle of 60° in a half period or 120° in one period of the control voltage.

5. The method according to claim 2 further comprises shifting time points in a preceding group with a pre-defined offset to construct time points in a successive group.

6. The method according to claim 5, wherein the pre-defined offset is calculated based on a phase angle in a range of 5°-15°.

7. A low voltage contactor for connecting and disconnecting a three-phase load to an electric power including a coil, three contacts operated by the coil and an electronic control circuit for controlling voltage supplied to the coil, wherein each of contacts is connected to each of the phases,
characterized in that the electronic control circuit includes a pre-arranged time point selection scheme and is further adapted to
select a time point from the pre-arranged time point selection scheme (22) as a time delay, and
initiate an instant opening command based on the selected time point, wherein the time points are constructed in a way such that the initiated opening commands based thereon are evenly distributed on each of the contacts.

8. The low voltage contactor according to claim 7, wherein the time point selection scheme including a plurality of time points distributed in a period of the control voltage, wherein the time points in the pre-arranged time point selection scheme are divided into groups, each of the groups including at least three time points distributed in the period with a pre-defined interval.

9 The low voltage contactor according to claim 7, wherein the time point selection scheme is stored in memory storage in any form of non-volatile memory.
